(19) United States
(12) Patent Application Publication
(10) Pub. No.: US 2024/0275320 A1
(43) Pub. Date: Aug. 15, 2024

(54) Method for Determining a Synchronous Speed

(71) Applicant: KSB SE & CO. KGAA, Frankenthal (DE)

(72) Inventors: Boris JANJIC, Frankenthal (DE); Tobias KLUNKE, Frankenthal (DE); Jochen MADES, Frankenthal (DE)

(21) Appl. No.: 18/021,877

(22) PCT Filed: Aug. 12, 2021
(86) PCT No.: PCT/EP2021/072446

§ 371 Date: Feb. 17, 2023

(30) Foreign Application Priority Data
Aug. 18, 2020 (DE) 10 2020 005 050.6

(51) Int. Cl. H02P 23/14; F04D 1/00; F04D 15/00; G01P 3/02

(52) U.S. Cl. CPC H02P 23/14; F04D 1/00; F04D 15/0088; G01P 3/02; H02P 2207/01

(57) ABSTRACT

A method for determining a synchronous speed of an electric machine, in particular a speed-controlled asynchronous machine, in a work machine driven by the electric machine is provided. A control device is provided for controlling the speed of the electric machine. The method includes the steps of initiating a detection of at least one mechanical measurement variable in the electric machine and/or the driven work machine to obtain detection information specific to a rotation-induced sound of the electric machine and/or the driven work machine, carrying out a frequency analysis of the detection information to obtain a frequency spectrum of the detection information, carrying out a selection of at least one frequency range in the frequency spectrum on the basis of a clock frequency of the control device, carrying out an identification of at least one peak value in the frequency range to determine at least one frequency specific to the synchronous speed, and carrying out the determination of the synchronous speed using the at least one determined frequency.

### CROSS REFERENCE TO RELATED APPLICATION

This application claims priority under 35 U.S.C. § 119 from German Patent Application No. 102020005050.6, filed Aug. 18, 2020, the entire disclosure of which is herein expressly incorporated by reference.

### BACKGROUND AND SUMMARY OF THE INVENTION

The present invention relates to a method for determining a synchronous speed of an electric machine in a work machine driven by the electric machine. Furthermore, the invention relates to a processing device, a system, and a computer program.

In the operation of a pump assembly, in particular a centrifugal pump assembly, consisting of the pump and the electric machine driving it, in particular an asynchronous machine, a statement about its operating point is often required. The operating point of a fluid work machine, in particular a centrifugal pump, on its delivery flow-delivery head characteristic curve or Q-H characteristic curve, is characterized in particular by its delivery flow, also referred to as a delivery amount hereinafter. There are various possibilities for its ascertainment. It can be determined via the measurement of the delivery flow or by a pressure measurement. In the latter case, the difference of the pressure between pressure side and suction side of the pump is typically measured. The delivery head is estimated as the quotient of pressure difference, density, and acceleration due to gravity. In the case of water as the delivery fluid, a pressure difference of 1 bar corresponds to a delivery head of approximately 10 meters. Furthermore, an operating point of a centrifugal pump is determined by an electrical measurement, wherein the output motor power is calculated in consideration of the efficiency of the motor from a current and voltage measurement.

A device and a method are known from EP 2 433 010 B1, in order to determine the operating point of a work machine and/or an asynchronous motor driving it. The method disclosed therein or the device disclosed therein can be used for unregulated asynchronous machines or asynchronous machines running on the grid, since in these cases the synchronous speed of the electric machine is known. The synchronous speed results in this case, for example, from the grid frequency multiplied by the number of pole pairs. In contrast, the determination of the operating point of the work machine is problematic if it is driven by a speed-regulated asynchronous machine, and thus the synchronous speed is not known.

It is therefore an object of the present invention to remedy the above-described problems at least partially. In particular, it is the object of the present invention to propose an improved possibility for determining a synchronous speed, and/or to expand an application of a known method for operating point determination without use of electrical measured variables for speed-regulated asynchronous machines.

The above object is achieved by a method having the features of claim 1, a processing device having the features of claim 12, a system having the features of claim 13, and by a computer program having the features of claim 15. Further features and details of the invention result from the respective dependent claims, the description, and the drawings. Features and details which are described in conjunction with the method according to the invention obviously also apply here in conjunction with the processing device according to the invention, the system according to the invention, and the computer program according to the invention, and vice versa in each case, so that reference always is or can be made mutually with respect to the disclosure of the individual aspects of the invention.

The object is achieved in particular by a method for determining a synchronous speed of an electric machine, in particular a speed-regulated asynchronous machine and/or synchronous machine and/or rotating electric machine and/or an electric motor, in particular an asynchronous motor, in a work machine driven by the electric machine, in particular a pump assembly.

For this purpose, an (electric) regulating device such as a frequency converter can advantageously be provided for speed regulation of the electric machine, in particular the asynchronous machine.

Furthermore, the following method steps can be carried out, preferably in succession in the specified sequence or in an arbitrary sequence, wherein individual and/or all steps can also be carried out repeatedly:
initiating and/or carrying out a detection of at least one (in particular mechanical) measured variable in the electric machine and/or the work machine, preferably to obtain an item of detection information specific for a rotation sound of the electric machine and/or the work machine and/or for the synchronous speed, in particular in the form of an item of noise information and/or a time curve of the measured variable,
carrying out a signal analysis, in particular a frequency analysis, of the detection information to obtain a spectrum, in particular a frequency spectrum, of the detection information,
carrying out a selection of at least one range in the spectrum, in particular at least one frequency range in the frequency spectrum, preferably on the basis of a clock frequency (which is in particular previously known and/or manually input) of the regulating device, wherein alternatively or additionally the selection of multiple different ranges can also be carried out on the basis of at least one multiple of the clock frequency and/or different multiples of the clock frequency,
carrying out a recognition of at least one peak value (peak) in the (respective, selected) range, in particular the frequency range, to ascertain at least one or precisely two or at least two frequency (frequencies) specific for the synchronous speed (in this respective range), wherein the frequency (frequencies) can each be a frequency of a harmonic, thus in particular frequencies which are excited by harmonics of the regulating device,
carrying out the determination of the synchronous speed on the basis of the at least one ascertained frequency.

This has the advantage that the synchronous speed can be determined even without access to electrical measured variables of the work machine, in particular the electric machine and/or the regulating device, and/or without knowledge of the regulating parameters of the regulating device. The regulating parameters are, for example, a set speed and/or a control variable or the like which are used for speed regulation. In a speed-regulated electric machine or asynchronous machine, the synchronous speed can furthermore deviate from the rated speed, and can always be just above the rated speed, for example. The magnetic rotating field in the asynchronous machine in particular only induces voltages and currents in the rotor strands when the rotor revolves asynchronously to the magnetic rotating field. The differential speed between rotating field and rotor with respect to the rotating field speed, i.e., the synchronous speed, is referred to as slip.

It is possible that the steps of carrying out the selection and carrying out the recognition and carrying out the determination of the synchronous speed are carried out for different ranges in the spectrum which comprise the clock frequency and/or a multiple of the clock frequency and/or different multiples of the clock frequency. For example, at least two or at least three different ranges in the spectrum can be selected on the basis of the clock frequency and/or a multiple of the clock frequency and/or different multiples of the clock frequency. Each of the ranges can therefore comprise a different multiple of the clock frequency or also the clock frequency itself. The peak values can be recognized in each of the ranges to ascertain each of the frequencies which are specific for the synchronous speed. For each range, a value for the synchronous speed can then be ascertained on the basis of the frequencies ascertained therein. The ascertained values can furthermore be used jointly to determine the synchronous speed to increase the accuracy. Carrying out the selection on the basis of the clock frequency therefore also comprises carrying out the selection on the basis of at least one multiple of the clock frequency.

The determination of the synchronous speed is advantageously carried out on the basis of the detection of at least one such measured variable, which occurs only as a side effect of the operation of the electric machine or work machine, but nonetheless offers inferences about the synchronous speed. This can specifically be a sound (for example, structure-borne sound or airborne sound), so that the measured variable can also be understood as a noise emitted by the electric machine or work machine. The measured variable can provide items of information about the synchronous speed in this case. These items of information can also result from an effect of the operation fundamentally considered to be annoying, for example, a noise behavior of the regulating device. The items of information can furthermore be specific for the rotational sound of the electric machine and/or work machine, thus, for example, can be induced as the noise by periodic alternating forces in the electric machine and/or work machine. The detection of the measured variable is used here to make these items of information accessible to processing by way of the detection information. For this purpose, a conversion of the measured variable to the detection information can take place in the detection, for example, by a sound transducer and/or by an analog to digital conversion.

The regulating device can have at least one power-electronics switch for the speed regulation of the electric machine or asynchronous machine, in particular in the form of controlled bridges. The at least one switch can be formed, for example, as a power transistor, preferably as a metal oxide semiconductor field effect transistor (MOSFET), junction-gate field effect transistor (JFET), insulated gate bipolar transistor (IGBT), or as IGC thyristors. Furthermore, a variable output voltage can be generated in the regulating device by a pulse width modulation (PWM). In this way, the level of the resulting output voltage and also its frequencies can be regulated in broad limits.

It is possible that the detection information is specific for the rotational sound and/or the synchronous speed in that the detection information results from a noise generation in the electric machine and/or work machine. Specifically, annoying noises can arise upon the use of a PWM clock frequency in the audible range for the regulating device. These are induced, for example, by mechanical oscillations of the stator. Increasing the clock frequency can result in the reduction of this effect, but also in the increase of a power loss of the frequency converter. According to the invention, however, the noise generation can also be used for the purpose of determining the synchronous speed of the electric machine on the basis of the noise generation. The resulting noises in the electric machine can be made available, for example, to processing (thus the further method steps such as the signal analysis, etc.) as detection information by the detection of the measured variable, to thus determine the synchronous speed by the processing. The effect can be utilized here that the synchronous speed has an influence on these noises, in particular due to an amplitude modulation of the rotational frequency of the regulating device. The frequencies ascertained by the recognition of the at least one peak value can therefore also be specific for the synchronous speed.

It is furthermore conceivable that at least one windowing of the frequency spectrum is carried out to select the at least one frequency range. For this purpose, a window width and/or a window position can be defined for the windowing (thus of the window) in such a way that only (one or more) such frequencies of the frequency range, which are specific for the synchronous speed, are ascertained by the subsequent recognition of the at least one peak value or at least two or precisely two peak values in the respective frequency range. As described above, an inference about the synchronous speed can take place on the basis of the detection information. In particular, the synchronous speed has an effect here on the spectrum of the detection information. For example, in the case of a PWM, oscillations characteristic for the synchronous speed are excited, the frequencies of which occur around the clock frequency or a multiple of the clock frequency of the regulating device. The distance of these frequencies to the clock frequency or multiple can be dependent here on the synchronous speed. The window parameters window width and/or window position can then be defined so that the at least one frequency range resulting from the at least one windowing comprises these frequencies but excludes other similarly strong or stronger frequencies in the frequency spectrum. This has the advantage that only these frequencies are ascertained in the subsequent recognition of the peak values. The specific definition of the window parameters to achieve this desired function can be carried out, for example, by a manual setting in the nature of a calibration, before the method according to the invention is used.

Furthermore, it is conceivable that the regulating device is designed as a frequency converter. Alternatively or additionally, the at least one frequency range can be selected around the clock frequency and/or around at least one multiple of the clock frequency, and can preferably in each case have the clock frequency or the multiple of the clock frequency as the center frequency. Upon the selection, at least one window for the selection of the at least one frequency range is located centrally around the clock frequency and/or the at least one multiple of the clock frequency in the windowing. In this way, the frequencies can be selected which occur at a distance to this clock frequency and/or multiple of the clock frequency, wherein this distance can be dependent on the synchronous speed. In other words, one or more windowings can be carried out upon the selection, by which in each case a frequency range around the clock frequency and/or a multiple thereof is obtained.

Furthermore, it is optionally provided that carrying out the selection comprises the following steps:
defining (at least) one window width on the basis of a predefined expected synchronous speed,
defining (at least) one window position on the basis of the clock frequency, in particular at the clock frequency and/or at least one multiple of the clock frequency, for example, at the position of the clock frequency or multiple of the clock frequency, so that the clock frequency or multiple of the clock frequency forms the center frequency for the frequency range,
carrying out at least one windowing of the frequency spectrum in each case to select the frequency range as a region around the clock frequency or the multiple of the clock frequency having the defined window width and window position.

This procedure enables only the relevant frequencies to be selected, which can be used to determine the synchronous speed. It is possible that the above-mentioned steps for carrying out the selection are carried out repeatedly for different window positions, which are preferably defined on the basis of and/or at the clock frequency and/or a multiple of the clock frequency and/or different ones of the multiples of the clock frequency. In other words, the windowing can also be carried out multiple times for different ranges, and multiple frequency ranges can be selected by the windowings as ranges around the clock frequency and/or different multiples of the clock frequency. For each of the selected frequency ranges, a value for the synchronous speed can advantageously be estimated on the basis of the frequencies ascertained therein, to determine the synchronous speed on the basis of these values.

Furthermore, it is conceivable that the clock frequency is in the range from 1 kHz to 20 kHz, preferably 2 kHz to 16 kHz, preferably 4 kHz to 12 kHz. The range can accordingly be limited in which the selection of the frequency range takes place.

Furthermore, it is optionally provided that the mechanical measured variable differs from an electrical measured variable of the electric machine and/or the regulating device, and is preferably detected independently of a regulating parameter of the regulating device. The method according to the invention can thus be carried out even without direct access to the regulating device and/or the electric machine, for example, solely by the detection of the measured variable such as a sound pressure or the like.

It can preferably be provided that the mechanical measured variable comprises at least one of the following measured variables:
a pressure,
a differential pressure,
a force,
a vibration,
a structure-borne sound,
an airborne sound.

This enables the method according to the invention to be carried out without direct contacting of the electric machine and/or work machine, for example, by a processing device according to the invention, for example, in the form of a mobile measuring device.

It is also optionally conceivable that a window width of the frequency range is defined in such a way that during the subsequent recognition, precisely two or at least two peak values are recognized in order to ascertain one of the frequencies specific for the synchronous speed at each of the peak values, wherein the synchronous speed is determined on the basis of a frequency difference of the ascertained frequencies. This enables a reliable ascertainment of the synchronous speed.

According to a further possibility, it can be provided that the window width of the frequency range is at least two times or at least four times a synchronous frequency to be expected (according to the synchronous speed). It is therefore possible to reliably limit the range of the relevant frequencies. The window width can be, for example, at most two times or three times or four times or six times the expected synchronous speed.

A processing device is also the subject matter of the invention, for example, a measuring device which is also designed for processing, in particular data processing. It is provided for this purpose that the processing device has means for the processing, which are provided to execute the steps of a method according to the invention. The processing device according to the invention is therefore accompanied by the same advantages as have been described in detail with reference to a method according to the invention.

A system is also the subject matter of the invention, comprising:
a work machine, in particular a pump assembly,
an electric machine, in particular a speed-regulated asynchronous machine, in particular the work machine, to drive the work machine, preferably to generate a rotational movement in the work machine to deliver a medium to be delivered,
a regulating device of the work machine and in particular the electric machine, preferably for speed regulation of the electric machine, in particular to set a present speed of the rotational movement,
a processing device according to the invention.

The system according to the invention is therefore accompanied by the same advantages as have been described in detail with reference to a processing device according to the invention and/or a method according to the invention.

Furthermore, it can be provided in the scope of the invention that the work machine is designed as a pump assembly, in particular a centrifugal pump assembly, and/or the processing device is embodied separately from the work machine, in particular in the form of a mobile device.

A computer program is also the subject matter of the invention, in particular a computer program product comprising commands which, upon the execution of the computer program by a processing device according to the invention, prompt it to carry out a method according to the invention. The computer program according to the invention is therefore accompanied by the same advantages as have been described in detail with reference to a method according to the invention. The processing device can have a processor for executing the computer program, which reads the computer program out of a nonvolatile memory of the processing device for this purpose.

The solution according to the invention can be used to carry out the method described in document EP 2 433 010 B1 and/or to operate the device described therein for operating point determination. Specifically, the method according to the invention and/or the processing device according to the invention can be used to determine the synchronous speed (also referred to hereafter as the synchrony speed) for this purpose. Reference is therefore made to the above-mentioned patent document and also to the associated application (WO 2010/133425), the content of which is hereby incorporated in this application. It is therefore an advantage of the present invention that the scope of application of the above-mentioned patent can be expanded to speed-regulated asynchronous machines.

For example, it can be provided that the determined synchronous speed is used to determine an operating point of the work machine. The method according to the invention based on the determination of the synchronous speed can therefore also be used for operating point determination of the work machine or the electric machine driving the work machine. The work machine can be driven, for example, by the speed-regulated asynchronous machine (as the electric machine), in which the determination of the synchronous speed is conventionally not possible or is only possible in a technically complex manner. The operating point can be characterized by a power consumed by the work machine and/or its delivery amount.

It is thus conceivable, for example, that the following steps are carried out to determine the operating point on the basis of the synchronous speed and a present speed of the work machine deviating therefrom:
ascertaining a rotational sound frequency linearly proportional to the rotational sound of the work machine and/or electric machine from the frequency spectrum,
determining the present speed of the work machine on the basis of the ascertained rotational sound frequency,
determining a speed-torque characteristic curve of the electric machine, for example, at least on the basis of predetermined motor parameters such as rated power and/or rated speed and/or the synchronous speed,
determining a power consumed by the work machine from the ascertained present speed and the speed-torque characteristic curve, wherein the operating point is characterized by the consumed power.

One or more sensors can be used to detect the at least one measured variable, which detect the measured variable as an operating point-dependent measured variable of the work machine. The measured values ascertained in this way can be evaluated and/or stored by a method according to the invention during operation of the work machine. It can furthermore be provided in the invention that the operating point is determined without the use of electrical measured variables of the driving asynchronous motor. For this purpose, a frequency (rotational sound frequency) linearly proportional to the rotational sound of the work machine and/or electric machine can be ascertained from a mechanical measured variable such as pressure, differential pressure, force, vibration, structure-borne sound, or airborne sound by means of a signal analysis, in particular a frequency analysis. The speed of the drive machine can be ascertained therefrom and the operating point can be determined from the slip-related speed-torque dependence of the asynchronous motor. Furthermore, the consumed power of the work machine can be determined by the following steps (the electric machine is referred to hereinafter in short as a motor):
Determining the speed-torque characteristic curve of the motor, in particular by predetermined motor parameters such as rated power and rated speed, possibly synchronous speed, tilting moment, tilting speed, or tilting slip.
Determining the consumed power or the torque of the motor from ascertained drive speed (i.e., the present speed) and speed-torque characteristic curve of the motor.

In the case of a pump, in particular a centrifugal pump, as the work machine, it can be provided that the ascertainment of a delivery amount of the pump is carried out from the drive speed. Only mechanical measured variables are then detected on the pump. The drive speed or shaft speed of the pump can be ascertained from the ascertained rotational sound frequency. There is a significant cost advantage in relation to a direct measurement of the delivery amount, for example, by means of ultrasound flow rate metrology or magnetic-inductive flow rate metrology. Effort and costs are also minimized in relation to an ascertainment of the delivery amount on the basis of an electrical effective power measurement.

The processing device according to the invention can be arranged on the pump, on its drive motor, or in their surroundings and/or can be embodied integrated with the pump or its drive motor.

The processing device according to the invention can furthermore determine the delivery amount of the pump, in particular the centrifugal pump, from the consumed power or shaft power ascertained from the drive speed or shaft speed.

It has proven to be expedient that the processing device according to the invention determines the delivery amount of the pump, in particular the centrifugal pump, from parameters of the motor which describe a speed-torque characteristic curve of the motor, and from parameters of the pump which describe a delivery flow-power characteristic curve, and the drive speed or shaft speed.

It can also be provided that the processing device according to the invention determines the delivery amount of the pump, in particular the centrifugal pump, directly from a characteristic curve, which represents the load-dependent speed change over the delivery amount of the pump. Such a characteristic curve can be ascertained by test runs and stored in the data memory, so that it is retrievable during the operation of the centrifugal pump. The speed-torque dependency of the asynchronous motor is used similarly here, which results in a speed change over the delivery flow range. The operating point characterized by the power consumed by the work machine and/or its delivery amount can be determined particularly easily therefrom.

Motor parameters, which describe the speed-torque dependence of the asynchronous motor, and/or other technological data of the work machine assembly can be stored in a data memory of the processing device according to the invention. These can be accessed during the operation of the work machine for the purpose of determining the operating point. A detection of electrical measured variables by the processing device is not necessary. The processing device can determine the operating point of the work machine from a single measurement signal, for example, a pressure sensor signal.

It can also be provided that the processing device according to the invention has at least one connection for a pressure sensor and the drive speed or shaft speed is ascertained to determine the operating point of the work machine from measured values of a connected pressure sensor. Pressure sensors for detecting static pressures are also capable of detecting dynamic pressure variations. Such pressure sensors are connected to many pumps in any case, in particular to detect their final pressure.

The parameters necessary for carrying out the individual method steps can be stored or saved in a data memory of the processing device according to the invention and are thus available for carrying out the individual method steps.

Further advantages, features, and details of the invention result from the following description, in which exemplary embodiments of the invention are described in detail with reference to the drawings. The features mentioned in the claims and in the description can each be essential to the invention individually as such or in any arbitrary combination.

### BRIEF DESCRIPTION OF THE DRAWINGS

FIG. 1 shows a schematic illustration to visualize a method according to an embodiment of the invention,

FIG. 2 shows a schematic illustration of parts of a system according to an embodiment of the invention,

FIG. 3 shows a schematic illustration of windowing of the frequency spectrum to select the frequency range in accordance with an embodiment of the present invention,

FIG. 4 shows a schematic illustration of a recognition of peak values in the frequency range in accordance with an embodiment of the present invention,

FIG. 5 shows a schematic illustration of a frequency spectrum of a stator voltage,

FIG. 6 shows a schematic partial illustration of the frequency spectrum of the stator voltage,

FIG. 7 shows a schematic illustration of a frequency spectrum of a noise, and

FIG. 8 shows a schematic partial illustration of the frequency spectrum of the noise.

### DETAILED DESCRIPTION

In the following figures, identical reference signs are used for the same technical features, even of different exemplary embodiments.

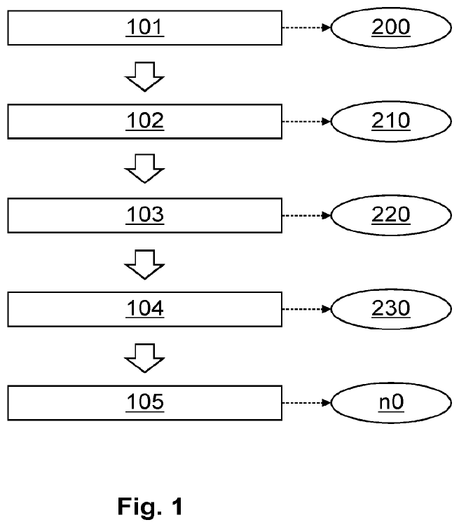

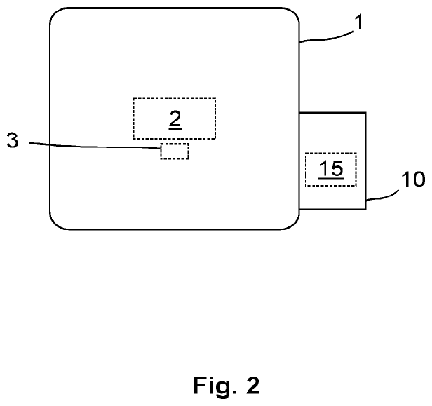

In FIG. 1, a method according to the invention for determining a synchronous speed n0 of an electric machine 2, specifically and by way of example in the form of a speed-regulated asynchronous machine 2, in a work machine 1 driven by the asynchronous machine 2 is schematically visualized with the associated method steps. As FIG. 2 shows, a regulating device 3 can be provided here for speed regulation of the asynchronous machine 2. The regulating device 3 can be part of a system according to the invention together with the work machine 1 and/or the processing device 10 according to the invention. In addition, the asynchronous machine 2 and the regulating device 3 can be part of the work machine 1, whereas the processing device 10 can be embodied as a mobile device separate from the work machine 1. A computer program according to the invention can be stored in a nonvolatile manner in a memory 15 of the processing device 10, in order to be executed by a processor (not explicitly shown) of the processing device 10 to carry out the method steps of a method according to the invention.

According to a first method step of a method according to the invention, an initiation of a detection 101 of at least one mechanical measured variable in the work machine 1 and/or electric machine 2 can take place in order to obtain an item of detection information 200 specific for a rotational sound of the work machine 1 and/or electric machine 2. For this purpose, for example, sensors such as pressure sensors and/or at least one microphone can be used in the work machine 1 and/or electric machine 2. The detection information 200 can subsequently be further processed, wherein the following method steps are provided for processing:
carrying out a frequency analysis 102 such as a Fourier transform of the detection information 200 in order to obtain a frequency spectrum 210 of the detection information 200,
carrying out a selection 103 of at least one frequency range 220 in the frequency spectrum 210 on the basis of a clock frequency fT (i.e., possibly also on the basis of at least one multiple of the clock frequency fT) of the regulating device 3,
carrying out a recognition 104 of at least one peak value 230 or at least one or precisely two peak values 230 in the (respective) frequency range 220, in order to ascertain at least one frequency f1, f2 specific for the synchronous speed n0,
carrying out the determination 105 of the synchronous speed n0 on the basis of the at least one ascertained frequency f1, f2.

The goal of determining the synchronous speed n0 can be to determine an operating point of the work machine 1. For the determination required for this purpose of the speed of the electric machine 2, in particular the asynchronous machine, of the work machine 1, in a first step the ascertainment of the present synchronous speed n0 of the electric machine 2 is necessary. It can be possible here in the method according to the invention that a study of a frequency spectrum in case of a noise of the work machine 1 and/or electric machine 2 can result in the determination of the present synchronous speed.

The magnetically excited acoustic noises in electric machines 2 can have different causes, for example, a stator and rotor usage, a stator and rotor saturation, a coupling between ground wave-air gap fields, which arise due to the converter-related current fundamental oscillation and current harmonic feed, the type of the converter feed, etc. In this case it can be a problem in the determination of the present synchronous speed n0 that the electric machine 2 is unknown, and therefore both the stator and rotor usage and also the stator and rotor saturation are unknown. It is thus advantageous, to ascertain the synchronous speed no, to evaluate the oscillation forces which arise in the air gap due to the coupling between the fundamental wave rotating fields, which are generated by the converter-related current fundamental oscillations and current harmonics. The current harmonics can be determined here by a type of the converter feed. The method according to the invention can be suitable here for the determination of the synchronous speed n0 in an electric machine 2, which uses asynchronous pulse width modulation (PWM) undershoot methods having a symmetrical triangular carrier signal.

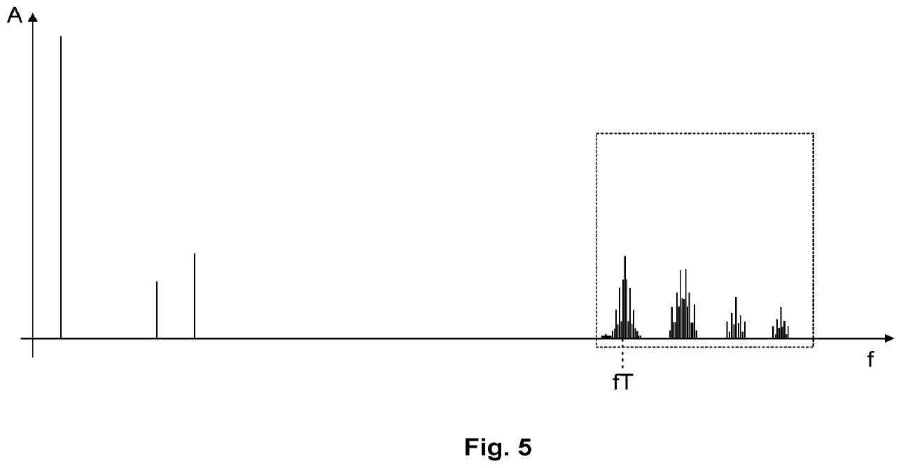

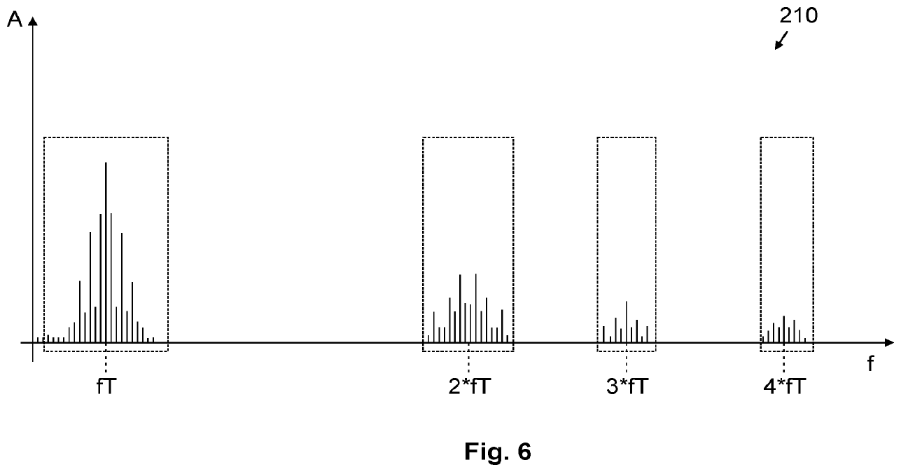

An exemplary frequency spectrum of a stator voltage of the electric machine 2 for an exemplary clock frequency fT of 4 kHz is shown in FIG. 5. The frequencies relevant for the method according to the invention are highlighted by a dashed rectangle and are shown enlarged in FIG. 6. It can be seen that in this case the characteristic frequency side bands (highlighted in FIG. 6 by a dashed rectangle) result around the multiples of the clock frequencies fT, thus, for example, 2*fT=8 kHz, 3*fT=12 kHz, etc. The dashed rectangles around the clock frequency fT or around the multiples thereof can also identify possible windows for the windowing here. The amplitudes of the respective frequency bands are additionally dependent on the degree of modulation (modulation index). The frequency side bands of the current and the voltage may be calculated using the clock frequency fT and the fundamental oscillation frequency fS as follows:

$${f}_{k} = {n}_{1} \cdot {f}_{T} \pm {n}_{2} \cdot {f}_{S} .$$

If n₁ is an odd whole number, then n₂ is an even whole number, and if n₁ is an even whole number, then n₂ is an odd whole number. For example, fₖ=f_{T}±2· f_{S}; f_{T}±4·f_{S}; . . . 2·f_{T}±f_{S}; 2·f_{T}±3·f_{S}; 2·f_{T}±5·f_{S}; . . . 3·f_{T}±2·f_{S}; 3·f_{T}±4·f_{S}; 3·f_{T}±6·f_{S}; . . . etc

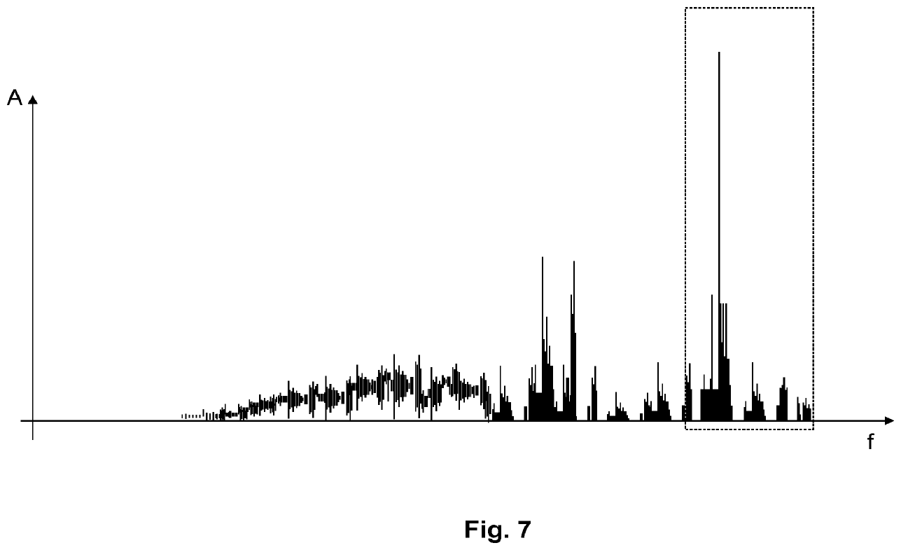

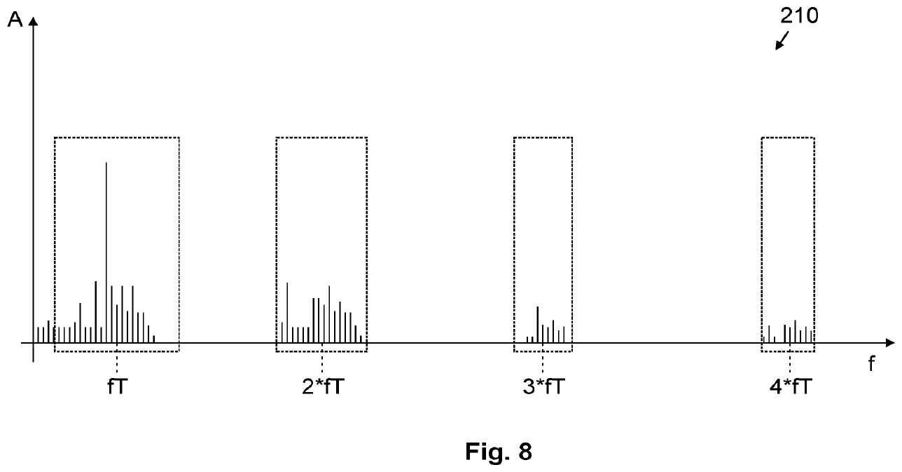

A frequency spectrum 210 of a noise of the work machine 2 operated on a speed-regulated asynchronous machine 2 is shown by way of example in FIG. 7. The frequencies relevant for the method according to the invention are identified by the dashed rectangle, which are excited by the harmonics of the frequency converter. An enlarged illustration of these frequencies is schematically shown in FIG. 8.

Similarly as with the stator current and the stator voltage (see FIGS. 5 and 6), characteristic frequency side bands also result in the noise of the work machine or electric machine 2. These frequency side bands are highlighted in FIG. 8 by dashed rectangles, and also result around the multiple of the clock frequency fT (4 kHz here by way of example). However, these noise frequencies are shifted from the frequencies of the harmonics (due to the interaction between the fundamental wave and the fundamental waves of the harmonics) by the fundamental oscillation frequency fS. The frequency side bands of the noise may therefore be calculated using the clock frequency fT and the fundamental oscillation frequency fS as follows:

$${f}_{k} = {m}_{1} \cdot {f}_{T} \pm {m}_{2} \cdot {f}_{S} .$$

If m₁ is an odd whole number, then m₂ is an odd whole number, and if m₁ is an even whole number, then m₂ is an even whole number. For example, fₖ=f_{T}±f_{S}; f_{T}±3·f_{S}; . . . 2·f_{T}±2·f_{S}; 2·f_{T}±4·f_{S}; 2·f_{T}±6·f_{S}; . . . 3·f_{T}±5·f_{S}; 3·f_{T}±7·f_{S}; 3·f_{T}±9·f_{S}; . . . etc.

The present fundamental oscillation frequency fS of the asynchronous machine may be ascertained, for example, from two ascertained harmonics of the noise signal fₖ₌₁=f₁=f_{T}±f_{S} and fₖ₌₂=f₂=f_{T}−f_{S}:

$${f}_{S} = \frac{{f}_{k = 1} - {f}_{k = 2}}{2} = \frac{{f}_{T} + {f}_{S} - ( {f}_{T} - {f}_{S} )}{2} = {f}_{S} .$$

The synchronous speed n0 furthermore results from the fundamental oscillation frequency fS divided by the number of pole pairs p of the asynchronous machine 2:

$${n}_{0} = \frac{{f}_{S}}{p}$$

As soon as the synchronous speed n0 is known, the method disclosed in document EP 2 433 010 B1 can advantageously furthermore be applied to determine the operating point of the work machine 1. Furthermore, the accuracy can also be increased by the analysis or the comparison of the frequencies in multiple frequency windows.

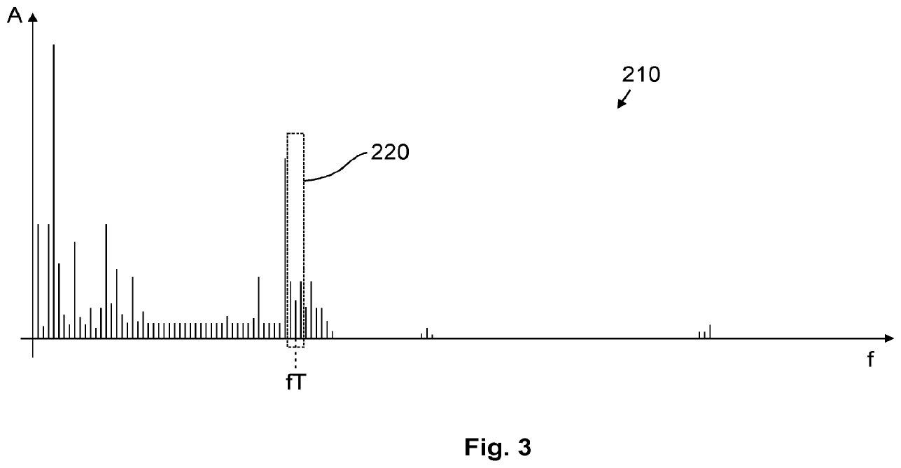

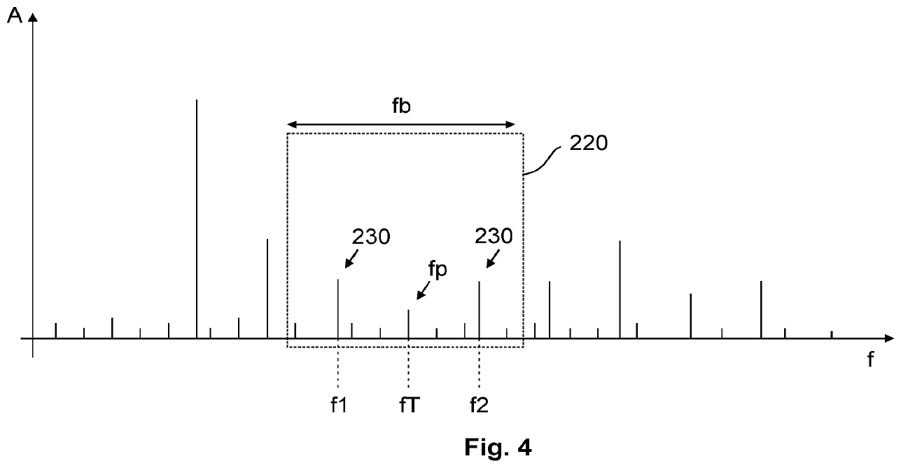

For the ascertainment of the harmonics, the frequency spectrum shown in FIGS. 7 and 8 can be evaluated by means of a windowing and a peak value recognition. As shown in FIG. 3, carrying out the selection 103 can optionally comprise carrying out a windowing of the frequency spectrum 210. For this purpose, firstly a window width fb—identified in FIG. 4—can be defined on the basis of a predefined expected synchronous speed no. The minimum window width, which has to be observed around the clock frequency and/or a multiple of the clock frequency of the regulating device 3, in particular a frequency converter 3, may be determined by

±2·maximum fundamental oscillation frequency to be expected

The window position can subsequently be defined on the basis of the clock frequency fT. In the example shown, the window position corresponds to the clock frequency fT, so that the clock frequency can be understood as the center frequency of the frequency range 220. Alternatively or additionally, at least one windowing can also be carried out, in which the window position corresponds in each case to a multiple of the clock frequency fT, so that the multiple of the clock frequency fT can be understood as the center frequency of the frequency range 220. This range can subsequently be cut out, i.e., a windowing of the frequency spectrum 210 can be carried out to select 103 the frequency range 220 as a range around the clock frequency fT having the defined window width fb and window position. Specifically, in this case the window width fb and the window position can be defined here for the windowing (for example by test series) in such a way that due to the subsequent recognition 104 of the at least one peak value 230 or at least or precisely two peak values 230 in the frequency range 220, only those frequencies f1, f2 of the frequency range 220 are ascertained which are specific for the synchronous speed n0 (see FIG. 4). For the recognition of the peak values 230, for example, the amplitudes of the frequencies in the frequency range 220 can be compared to a threshold value in order to select the frequencies as frequencies f1, f2 specific for the synchronous speed n0, which exceed this threshold value. In other words, the amplitudes A can be understood as peak values 230 which exceed the threshold value.

The present synchronous speed n0 of the electric machine 2 may thus be determined by an examination of the frequency spectrum 210 in ranges around the multiple of the clock frequency fT. Possible clock frequencies can be, for example, 2 kHz, 4 kHz, 6 kHz, 8 kHz, 10 kHz, 12 kHz, 14 kHz, or 16 kHz.

According to FIGS. 3 and 4, a window width fb of the frequency range 220 can be defined in such a way that upon the subsequent recognition 104, precisely or at least two peak values 230 are recognized in order to ascertain one of the frequencies f1, f2 specific for the synchronous speed n0 at each of the peak values 230. These can be the frequencies fₖ₌₁ and fₖ₌₂ of the harmonics, as was described above. The synchronous speed n0 can subsequently be determined on the basis of a frequency difference of the ascertained frequencies f1, f2, for example, as described above.

In FIG. 4, the frequency range around fT=4 kHz is shown by way of example. The characteristic harmonics are excited by the regulating device. It is obvious that characteristic peak values 230 (peaks) are present both above and also below fT=4 kHz. In the observed frequency range 220, multiple peaks are found, of which those closest to the clock frequency are observed further. The present synchronous speed n0 of the electric machine 2 may be calculated from the frequencies f1, f2 of these two closest peak values 230.

As soon as the synchronous speed n0 is known, the method from EP 2 433 010 B1 can be applied further to determine the operating point of the work machine. To determine the present slip s of the asynchronous machine, the present speed n and the synchronous speed no of the electric machine 2 can be used:

$$s = \frac{{n}_{0} - n}{{n}_{0}}$$

The present speed n can be determined in this case by means of conventional methods from the frequency spectrum of the detection information 200 shown in FIG. 3, in particular a noise.

Furthermore, the following steps can be carried out to determine the operating point on the basis of the synchronous speed n0 and a present speed of the work machine 1 deviating therefrom:
ascertaining a rotational sound frequency linearly proportional to the rotational sound of the work machine 1 from the frequency spectrum 210,
determining the present speed of the work machine 1 on the basis of the ascertained rotational sound frequency,
determining a speed-torque characteristic curve of the asynchronous machine 2 at least on the basis of predetermined motor parameters such as rated power and rated speed and the synchronous speed n0,
determining a power consumed by the work machine 1 from the ascertained present speed and the speed-torque characteristic curve, wherein the operating point is characterized by the consumed power.

Required parameters for determining the speed-torque characteristic curve (n−M characteristic curve) of the asynchronous machine 2 can furthermore be derived from the nameplate data of the asynchronous machine 2, for example, the rated or nominal torque MN results from the quotient of rated power of the asynchronous machine 2 (P2N) and the nominal speed (nN) as

$${M}_{N} = \frac{{P}_{2 N}}{{ω}_{N}} = \frac{{P}_{2 N}}{2 π {n}_{N}}$$

With known tilting moment MK and/or tilting slip sK of the asynchronous machine 2, using the Kloss equation

$$\frac{M}{{M}_{k}} = \frac{2}{\frac{s}{{s}_{k}} + \frac{{s}_{k}}{s}}$$

the speed-torque characteristic curve, n-M characteristic curve of the asynchronous machine 2 is depicted. Using the slip s of the asynchronous machine 2

$$s = \frac{{n}_{0} - n}{{n}_{0}}$$

the curve of the n-M characteristic curve results as

$$M ( n ) = \frac{2 {M}_{k}}{\frac{{n}_{0} - n}{{n}_{0} - {n}_{k}} + \frac{{n}_{0} - {n}_{k}}{{n}_{0} - n}}$$

with the tilting speed nk

$${n}_{k} = {n}_{0} \cdot ( 1 - ( \sqrt{{( \frac{{M}_{k}}{{M}_{N}} \frac{{n}_{0} - {n}_{N}}{{n}_{0}} )}^{2} - {( \frac{{n}_{0} - {n}_{N}}{{n}_{0}} )}^{2}} + \frac{{M}_{k}}{{M}_{N}} \frac{{n}_{0} - {n}_{N}}{{n}_{0}} ) )$$

In this way, the work machine 1 can be reliably characterized on the basis of the n-M characteristic curve, wherein the synchronous speed required for this purpose is ascertained by means of the method according to the invention.

The above explanation of the embodiments describes the present invention exclusively in the scope of examples. Of course, individual features of the embodiments can be freely combined with one another, if technically reasonable, without leaving the scope of the present invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 work machine
2 asynchronous machine, asynchronous motor
3 regulating device, frequency converter
10 processing device
15 memory
101 detection
102 frequency analysis, Fourier analysis
103 selection, windowing
104 recognition, peak recognition
105 determination, calculation
200 detection information
210 frequency spectrum
220 frequency range
230 peak value, peak
f frequency
fT clock frequency
fb window width
f1 first ascertained frequency
f2 second ascertained frequency
n0 synchronous speed, synchronization speed
A am

1-15. (canceled)

16. A method for determining a synchronous speed of a speed-regulated asynchronous machine in a work machine driven by the electric machine, the asynchronous machine having a regulating device configured to regulate a speed of the electric machine, comprising the steps of:
initiating a detection of at least one mechanical measured variable in one or both of the electric machine and the driven work machine to obtain an item of detection information specific for a rotational sound of one of both of the electric machine and the driven work machine;
conducting a frequency analysis of the detection information to obtain a frequency spectrum of the detection information;
selecting at least one frequency range in the frequency spectrum on the basis of a clock frequency of the regulating device;
recognizing at least one peak value in the frequency range;
determining from the at least one peak value in the frequency range at least one frequency specific for the synchronous speed; and
determining the synchronous speed on the basis of the at least one ascertained frequency.

17. The method as claimed in claim 16, wherein
the selection of the at least one frequency range includes at least one windowing of the frequency spectrum, and
in each case a window width and a window position for the windowing are selected such that in the subsequent steps of recognition of the at least one peak value in the at least one respective frequency range and of determining from the at least one peak value in the frequency range at least one frequency specific for the synchronous speed, only frequencies specific for the synchronous speed of the windowed frequency range are determined.

18. The method as claimed in claim 17, wherein
the regulating device is designed a frequency converter,
the at least one frequency range is selected one or both of around the clock frequency and around at least one multiple of the clock frequency, with the at least one frequency range having a center frequency.

19. The method as claimed in claim 18, wherein
the step of selecting at least one frequency range includes
defining the window width based on a predefined expected synchronous speed,
defining the window position based on the clock frequency or the multiple of the clock frequency,
carrying out a windowing of the frequency spectrum to select the frequency range as a range around one or both of the clock frequency and the multiple of the clock frequency using the defined window width and the defined window position, and
repeating the selecting step is carried out repeatedly for different window positions.

20. The method as claimed in claim 19, wherein
the clock frequency is in the range from 1 kHz to 20 kHz.

21. The method as claimed in claim 20, wherein
the clock frequency is in the range from 2 kHz to 16 kHz.

22. The method as claimed in claim 21, wherein
the clock frequency is in the range from 4 kHz to 12 kHz.

23. The method as claimed in claim 16, wherein
the mechanical measured variable differs from one of both of an electrical measured variable of the electric machine and an electrical measured variable of the regulating device, and
the mechanical measured variable is detected independently of a regulating parameter of the regulating device.

24. The method as claimed in claim 23, wherein
the mechanical measured variable includes one or more of a pressure, a differential pressure, a force, a vibration, a structure-borne sound, and an airborne sound.

25. The method as claimed in claim 16, wherein
a window width of the frequency range is determined such that in the step of recognizing the at least one peak value in the frequency range, at least two peak values are recognized, and
in the step of determining from the at least one peak value in the frequency range, the recognized at least two peak values are used to determine respective ones of the at least one frequency specific for the synchronous speed, and
in the step of determining the synchronous speed, the synchronous speed is determined based on a frequency difference between the at least two frequency specific for the synchronous speed.

26. The method as claimed in claim 16, wherein
a window width of the frequency range is determined such that in the step of recognizing the at least one peak value in the frequency range, precisely two peak values are recognized, and
in the step of determining from the at least one peak value in the frequency range, the recognized two peak values are used to determine two frequencies specific for the synchronous speed, and
in the step of determining the synchronous speed, the synchronous speed is determined based on a frequency difference between the two frequencies specific for the synchronous speed.

27. The method as claimed in claim 16, further comprising the step of:
determining an operating point of the work machine based on the determined synchronous speed.

28. The method as claimed in claim 27, wherein
the step of determining an operating point of the machine includes
determining a rotational sound frequency linearly proportional to the rotational sound of one of both of the electric machine and the work machine from the frequency spectrum,
determining a present speed of the work machine based on the determined rotational sound frequency,
determining a speed-torque characteristic curve of the electric machine based on at least predetermined motor parameters, the predetermined motor parameters including at least one of a rated power, a rated speed, and the synchronous speed, and
determining a power consumed by the work machine from the determined present speed and the speed-torque characteristic curve, wherein the operating point corresponds to the consumed power.

29. A processing device for data processing, comprising:
a processor configured to execute the steps of the method claim 16.

30. A system, comprising:
a work machine;
an electric machine of the work machine configured to drive the work machine;
a regulating device of the work machine configured to regulate speed of the electric machine; and
a processing device configured to execute the steps of the method claim 16.

31. The system as claimed in claim 30, wherein
the work machine is a pump assembly, and
the processing device is arranged separately from the work machine

32. The system as claimed in claim 31, wherein
the work machine is a centrifugal pump assembly.

33. The system as claimed in claim 31, wherein
the processing device is a mobile device.

34. A non-transitory computer-readable medium, comprising:
a computer program which, when executed by a processing device processor, causes the method of claim 16 to be performed.
